(19) United States
(12) Patent Application Publication
(10) Pub. No.: US 2019/0128268 A1
(43) Pub. Date: May 2, 2019

(54) RATE CONTROL FOR AN INJECTION PUMP

(71) Applicant: SIRIUS INSTRUMENTATION AND CONTROLS INC., Edmonton (CA)

(72) Inventors: Colin Bussiere, Ardrossan (CA); Kirby Jabusch, Edmonton (CA)

(21) Appl. No.: 15/796,332

(22) Filed: Oct. 27, 2017

(51) Int. Cl. F04D 25/06; H02P 6/08

(52) U.S. Cl. CPC F04D 25/06; H02P 6/08

(57) ABSTRACT

A method and system for controlling injection rates of an injection pump powered by an electric motor, below a minimum speed of the electric motor, includes the implementation of an off and on duty cycle for the motor. The method and system includes automatic transitioning between continuous operation and off and on duty cycle operation.

### FIELD OF THE INVENTION

The invention relates to methods and systems for controlling injection rate of an injection pump.

### BACKGROUND

During production of oil and gas, it is often necessary to inject a treatment chemical into a well, often into the annular space between the well casing and production tubing. These chemicals might include demulsifiers, corrosion inhibitors, scale inhibitors, or paraffin inhibitors. The various chemicals and their intended effects are well known in the industry.

Rotary motors, typically electric or hydraulic motors, are used to power injection pumps which inject chemicals into a process. The motors are typically connected by a gearbox or transmission to a camshaft which reciprocates a plunger within a cylinder to pump fluid through an injection valve. The motors are controlled by electric motor controllers.

### SUMMARY OF THE INVENTION

The present invention relates to a method and system for controlling the injection rate of an injection pump to maintain a desired average chemical injection rate while also satisfying the system's component constraints.

In one aspect, the invention may comprise a method of controlling injection rates of an injection pump actuated by an electric motor below a minimum electric motor speed, comprising the step of cycling the electric motor off and on in a duty cycle ratio calculated to provide a desired injection rate below the injection rate of the minimum electric motor speed. Preferably, the electric motor is controlled to operate in continuous mode above its minimum speed and duty cycle mode below its minimum speed.

In another aspect, the invention may comprise an injection pump system comprising an electric motor and an electric motor controller, wherein the controller is adapted to operate the electric motor in continuous mode above its minimum speed and in an off and on duty cycle mode below its minimum speed.

The minimum motor speed may be mandated by the pump or a component other than the motor itself, such as a gear assembly or a flow meter.

### BRIEF DESCRIPTION OF THE DRAWINGS

In the drawings shown in the specification, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

FIG. 1 is a schematic representation of a motor and pump system, with a motor controller and a power source.

FIG. 2 is a graph of average injection plotted against motor speed.

FIG. 3 is a graph of an on/off duty cycle below a minimum speed and a transition to continuous mode above the minimum speed.

FIG. 4 is a schematic diagram of a basic DC motor controller.

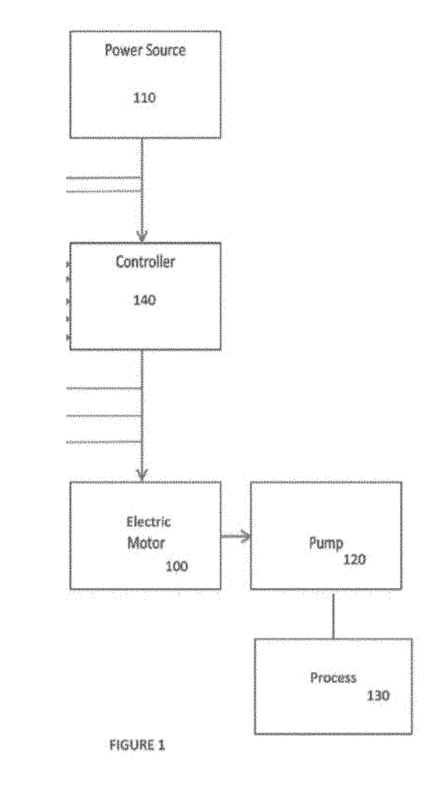

### DETAILED DESCRIPTION OF PREFERRED EMBODIMENTS

In one aspect, the invention may comprise a rate control system for controlling a positive displacement pump, actuated by an electric motor. The methods and systems described herein may be adapted to and added on to the methods and systems described in co-pending U.S. patent application Ser. No. 14/974,709, entitled “Method and System for Enhanced Accuracy of Chemical Injection Pumps”, the entire contents of which are incorporated herein by reference for all purposes, where permitted.

In the system and method according to the invention, an electric motor (100), powered by power source (110), is connected to and operates pump (120) that is configured to pump a chemical into process (130). Motor (100) may be, for example, one of the following types: DC Motor, AC Induction motor, permanent magnet synchronous motor (PMSM), or brushless DC motor (BLDC). Pump (120) may be, for example but not limited to, one of the following types of pumps: positive displacement piston driven, packed plunger, centrifugal, gear, vane, or diaphragm. Power source (110) may be for example, DC power from a battery or solar panel, DC power from battery, DC power from an engine skid, DC power from a thermoelectric generator, DC power from a fuel cell, DC generator, or alternator, or a combination of the above. Power source (110) may also be AC power from a generator, or a power grid, or an inverter, which converts power from DC or another frequency. Process (130) may be, for example, an oil or gas well, pipeline, valve, choke, separator, tank, downhole, flowline, or wellhead.

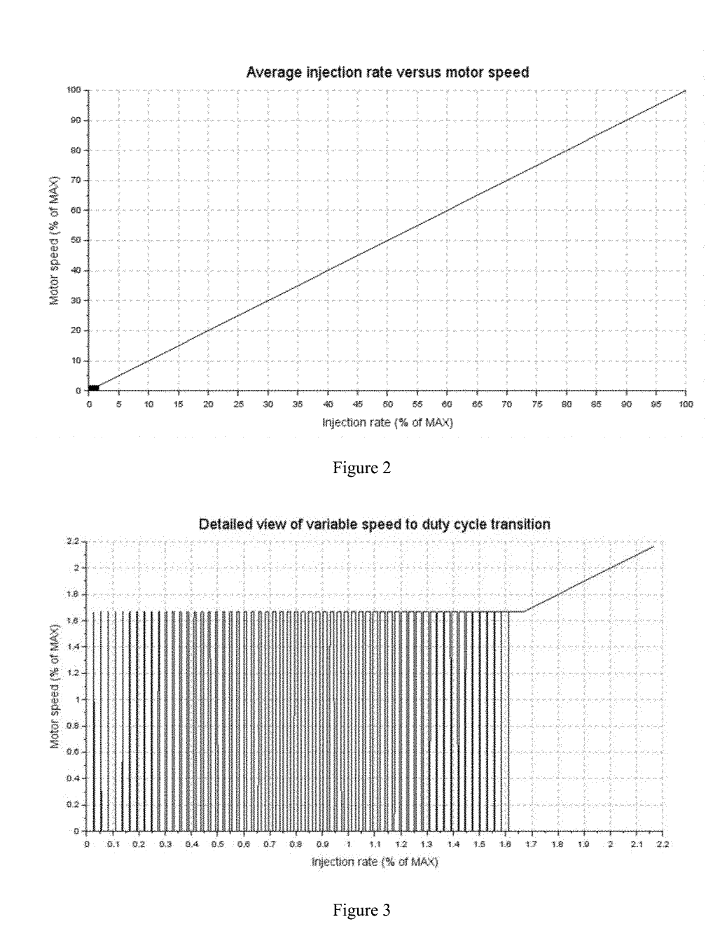

In one embodiment, rate control for the pump (120) may be provided below a minimum electric motor speed. Generally, average flow rates vary linearly with motor speed, as shown in FIG. 2. However, motors have a minimum speed of operation shown as the black rectangle in FIG. 2. That minimum speed is generally about 1.6% of maximum speed, below which the motor may stall or overheat. In order to provide flow rate control below this minimum speed, an alternative strategy is required. In one embodiment, one example of which is illustrated in FIG. 3, the motor is cycled on and off below the minimum speed.

Additionally, mechanical limitations of the pump itself or associated components such as gear assemblies or flow rate meters may mandate a minimum electric motor speed. For example, the pump may require a certain minimum speed to operate correctly, or a gear assembly may require a minimum speed to maintain lubrication, which means that the electric motor should not go below a certain speed, which may be greater than the minimum speed of the motor itself. In another example, the transition from continuous to duty cycle control can be motivated by the need to maintaining a minimum flow rate through injection control devices such as flow meters. Often such devices have a calibration span that does not extend down to zero flow thus requiring a lower flow rate limit.

An on/off cycle of 1:1 would provide an injection rate of about 50% of the set minimum speed. Where the minimum speed is 1.6% of maximum, in order to provide an injection rate of 1% of maximum, the motor is cycled on and off in a ratio of about 1:0.6. The motor controller may automatically select continuous mode for higher rates, switch automatically to duty cycle mode if an injection rate below the continuous minimum is selected, and then switch automatically to continuous mode for higher injection rates.

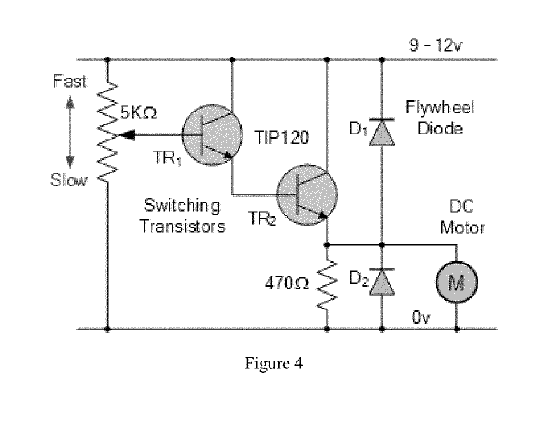

As a result, a very wide turndown in injection volume may be implemented without any mechanical changes to the pump. This method may be applied to any variable speed electric motor running an injection pump. Controllers for such variable speed electric motors are well known in the art, and adapting a motor controller to implement the on-off duty cycle described herein is well within the capability of one skilled in the art. A basic DC motor speed controller is shown below in FIG. 4. Below the minimum speed of the motor, the controller may be adapted to cycle on and off to achieve sub-minimum injection rates.

### Definitions and Interpretation

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A method of controlling injection rates of an injection pump actuated by an electric motor below a minimum electric motor speed, comprising the step of cycling the electric motor off and on in a duty cycle ratio calculated to provide a desired injection rate below the injection rate of the minimum electric motor speed.

2. The method of claim 1 wherein the electric motor is controlled to operate in continuous mode above its minimum speed and duty cycle mode below its minimum speed.

3. The method of claim 1 wherein the minimum motor speed is the result of a minimum speed required by the pump or an associated component.

4. The method of claim 3 wherein the associated component comprises a gear assembly or a flow meter.

5. An injection pump system comprising an electric motor and an electric motor controller, wherein the controller is adapted to operate the electric motor in continuous mode above a minimum speed and in an off and on duty cycle mode below the minimum speed.

6. The system of claim 5 wherein the controller transitions automatically between continuous mode and duty cycle mode.

7. The system of claim 5 wherein the minimum speed is the result of a minimum speed required by the pump or an associated component.

8. The system of claim 7 wherein the associated component comprises a gear assembly or a flow meter.
